(19) United States
(12) Patent Application Publication
(10) Pub. No.: US 2025/0110901 A1
(43) Pub. Date: Apr. 3, 2025

(54) POLLING CONTROL DEVICE, POLLING CONTROL SYSTEM, POLLING CONTROL METHOD, AND POLLING CONTROL PROGRAM

(71) Applicant: Nippon Telegraph and Telephone Corporation, Tokyo (JP)

(72) Inventors: Shogo SAITO, Musashino-shi, Tokyo (JP); Kei FUJIMOTO, Musashino-shi, Tokyo (JP)

(21) Appl. No.: 18/833,232

(22) PCT Filed: Feb. 8, 2022
(86) PCT No.: PCT/JP2022/004814

§ 371 Date: Jul. 25, 2024

(51) Int. Cl. G06F 13/22; G06F 1/3206

(52) U.S. Cl. CPC G06F 13/22; G06F 1/3206

(57) ABSTRACT

A server (30) includes a timing estimation unit (33) that estimates a processing time during which a dedicated processing unit (32) executes dedicated processing on current target data offloaded to the dedicated processing unit (32); and a polling control unit (38) that waits for execution of polling processing for requesting the dedicated processing unit (32) to transmit an execution result of the dedicated processing until the estimated processing time elapses, and executes the polling processing on the dedicated processing unit (32) when the estimated processing time has elapsed.

### TECHNICAL FIELD

The present invention relates to a polling control device, a polling control system, a polling control method, and a polling control program.

### BACKGROUND ART

For the purpose of flexible operation of facilities and reduction in hardware cost, a technique for implementing signal processing as software on a general-purpose server is spreading in a virtual radio access network (vRAN) or the like. In the implementation of signal processing as software, in particular, error correction code processing such as forward error correction (FEC) among the signal processing is offloaded to a dedicated processing unit mounted on the general-purpose server.

FIG. 5 is a configuration diagram of a server 30z that executes offloading.

The server 30z includes a CPU 70z, an OS 80z, and a server HW 90z.

The CPU 70z operates an offload source application 71z and dedicated software 72z that executes error correction code processing on the OS 80z. In addition, an accelerator (ACC) HW 91z that executes the error correction code processing is mounted as the server hardware (HW) 90z.

The offload source application 71z offloads the error correction code processing to a dedicated processing unit (the dedicated software 72z or the accelerator HW 91z) and obtains a processing result.

Non Patent Literature 1 describes that one of a “result reception technique by polling” and a “result reception technique by interrupt processing” is used as a method by which the offload source application 71z receives the processing result from the dedicated processing unit.

FIG. 6 is an explanatory diagram in a case where the offload processing result is acquired by polling.

The offload source application 71z continues to transmit a polling inquiry signal to the dedicated processing unit many times (illustrated by arrows). In response to the inquiry signal, the dedicated processing unit promptly returns the processing result to the offload source application 71z when the processing result is generated.

As a result, the time from the processing completion in the dedicated processing unit as an offload destination to the completion detection by the offload source application 71z is shortened, and real-time property can be secured.

FIG. 7 is an explanatory diagram in a case where the offload processing result is acquired by interrupt.

The processing result from the dedicated processing unit is returned to the offload source application 71z only once by an interrupt signal (illustrated by arrows).

As a result, the CPU 70z that operates the offload source application 71z does not need to apply a load for constantly monitoring the dedicated processing unit unlike polling in FIG. 6, and thus power saving is achieved.

### CITATION LIST

### Non Patent Literature

Non Patent Literature 1: DPDK (Data Plane Development Kit), “16. Wireless Baseband Device Library”, [online], [searched on Jan. 27, 2022], the Internet <URL: https://doc.dpdk.org/guides/prog_guide/bbdev.html>

### SUMMARY OF INVENTION

### Technical Problem

The polling method in FIG. 6 is excellent in real-time property, but has a high load due to polling that consumes 100% of the CPU (busy polling). On the other hand, the interrupt method in FIG. 7 achieves power saving, but there is an overhead when the CPU 70z detects the interrupt processing, and the real-time property is not satisfied.

Therefore, a main object of the present invention is to provide an offload processing result acquiring method that achieves both real-time property and power saving.

### Solution to Problem

In order to solve the above problems, a polling control device of the present invention has the following features.

The present invention is characterized in including: a processing time estimation unit that estimates a processing time during which a predetermined processing unit executes predetermined processing on current target data offloaded to the predetermined processing unit; and
a polling control unit that waits for execution of polling processing for requesting the predetermined processing unit to transmit an execution result of the predetermined processing until the estimated processing time elapses, and
executes the polling processing on the predetermined processing unit when the estimated processing time has elapsed.

### Advantageous Effects of Invention

According to the present invention, it is possible to provide an offload processing result acquiring method that achieves both real-time property and power saving.

### BRIEF DESCRIPTION OF DRAWINGS

FIG. 1 is a schematic diagram of a polling control system according to the present embodiment.

FIG. 2 is a hardware configuration diagram of a server according to the present embodiment.

FIG. 3 is a detailed configuration diagram of the polling control system according to the present embodiment.

FIG. 4 is a sequence diagram illustrating an operation of the polling control system according to the present embodiment.

FIG. 5 is a configuration diagram of a server that executes offloading.

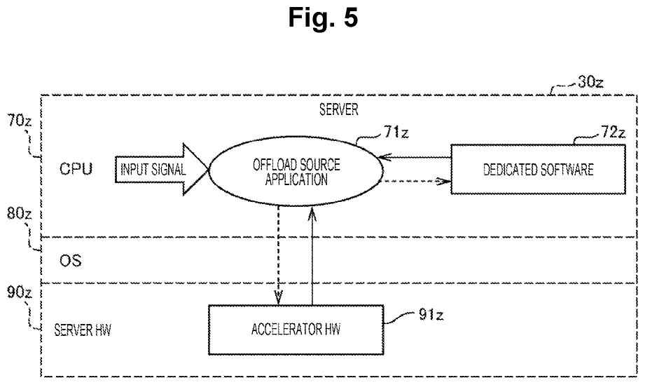

FIG. 6 is an explanatory diagram in a case where an offload processing result is acquired by polling.

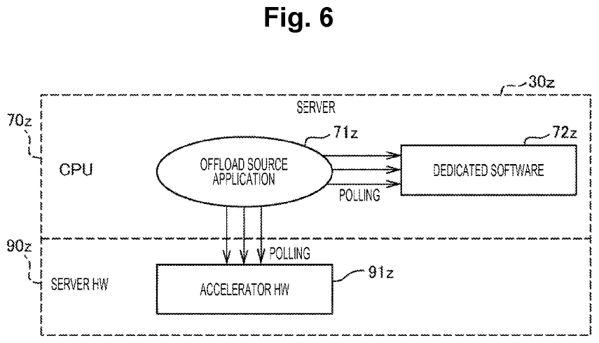

FIG. 7 is an explanatory diagram in a case where the offload processing result is acquired by interrupt.

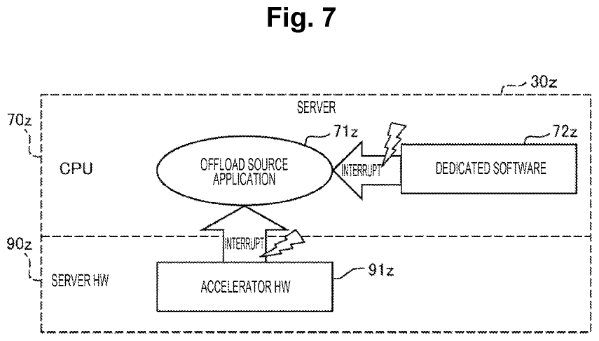

FIG. 8 is a configuration diagram in a case where an antenna is mounted on a communication server independent of the server according to the present embodiment.

### DESCRIPTION OF EMBODIMENTS

Hereinafter, an embodiment of the present invention will be described in detail with reference to the drawings.

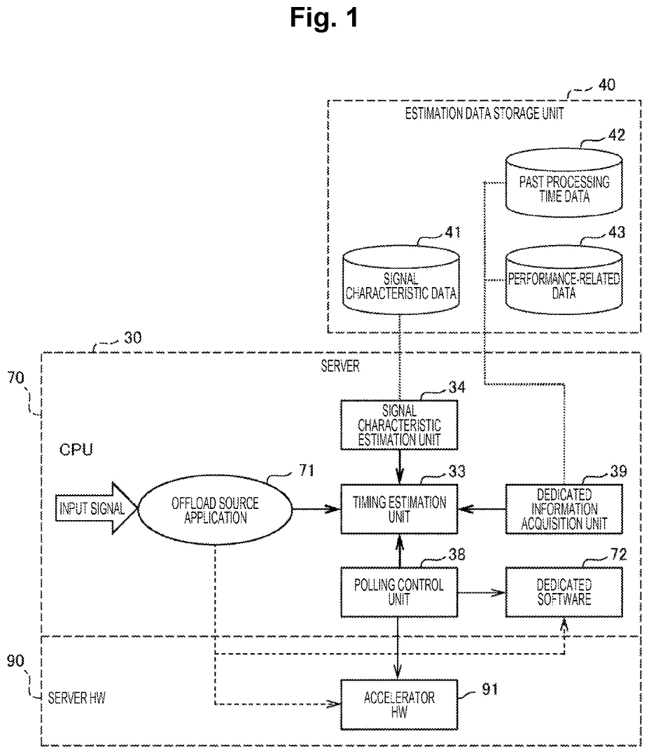

FIG. 1 is a schematic diagram of a polling control system.

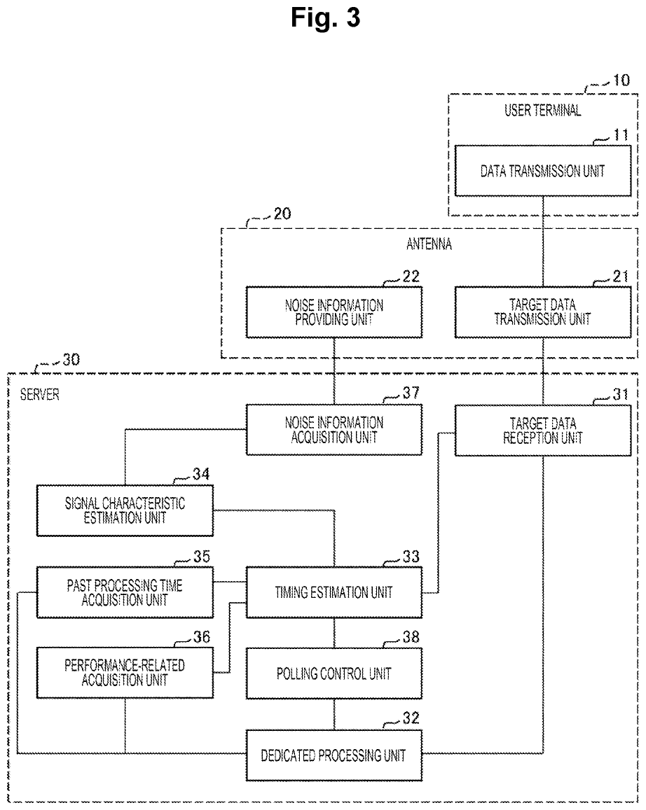

The polling control system is configured such that a server (polling control device) 30 including a CPU 70 and a server HW 90 is connected to a user terminal 10 in FIG. 3 via a network. In addition, the server 30 incorporates an estimation data storage unit 40 or is connected to the estimation data storage unit 40 in an accessible manner.

In order to achieve both real-time property and power saving, the server 30 executes the following (procedure 1) to (procedure 3).

(Procedure 1) A timing estimation unit (processing time estimation unit) 33 estimates, before offloading, a processing time required for dedicated processing (predetermined processing) to be offloaded such as error correction (time during which a dedicated processing unit (predetermined processing unit) 32 executes error correction code processing) with respect to target data on which the dedicated processing is performed. Note that an accelerator HW 91 or dedicated software 72 in FIG. 1 corresponds to the dedicated processing unit 32 in FIG. 3.

(Procedure 2) An offload source application 71 offloads the processing on the target data received as an input signal from the user terminal 10 in FIG. 3 to an offload destination such as the accelerator HW 91 or the dedicated software 72 (dashed arrows). Here, a polling control unit 38 performs control so as to wait for execution of the polling processing (stop polling) for the processing time estimated in (Procedure 1). As a result, the processing load of polling can be reduced, so that the power saving can be achieved.

(Procedure 3) After the elapse of the estimated processing time, the polling control unit 38 executes polling for obtaining a processing result of the target data from the offload destination (solid arrows). As a result, polling is executed at an appropriate timing when the offload destination is estimated to have prepared the processing result of the target data, so that the real-time property can be achieved.

Here, the higher the accuracy of estimating the processing time required for offloading in (Procedure 1), the better both the real-time property and the power saving can be achieved. Therefore, the timing estimation unit 33 refers to each piece of information of the estimation data storage unit 40 (signal characteristic data 41, past processing time data 42, and performance-related data 43) in order to estimate the processing time with high accuracy. The estimation data storage unit 40 provides information used for estimation processing by the timing estimation unit 33.

The signal characteristic data 41 is provided to the timing estimation unit 33 via a signal characteristic estimation unit 34.

The past processing time data 42 and the performance-related data 43 are provided to the timing estimation unit 33 via a dedicated information acquisition unit 39 that acquires information (dedicated information) affecting the processing time of the dedicated processing unit 32.

For example, the timing estimation unit 33 refers to the size of the target data included in the signal characteristic data 41 provided via the signal characteristic estimation unit 34 in (Procedure 1). In general, the larger the size, the longer the processing time.

Alternatively, the timing estimation unit 33 may estimate the processing time with reference to the amount of noise of the target data included in the signal characteristic data 41 in (Procedure 1). The noise is an unintended data error (garble) of the target data due to a radio wave defect. Causes of generation of noise include interference with other wireless signals or electromagnetic waves in a wireless section in which the target data is transmitted and the like.

Note that, in decoding processing of an error correction code, it is necessary to execute more iteration processing (iterations) based on a probability propagation model as the amount of noise included in the target data is larger. The error correction code is, for example, a low-density parity-check (LDPC) code, a Turbo code, or the like. Therefore, the larger the amount of noise, the longer the processing time.

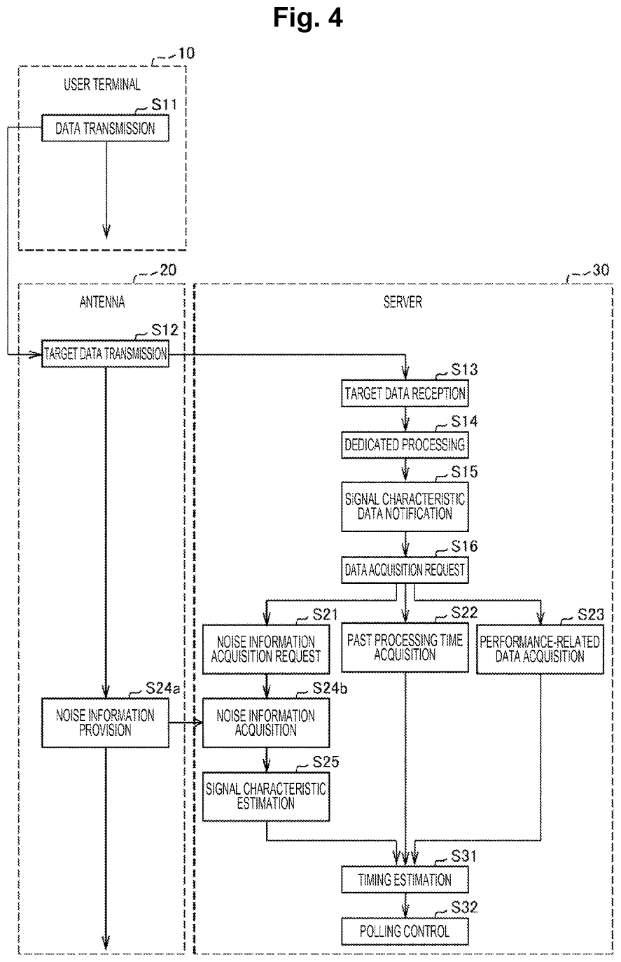

Incidentally, processing in which the timing estimation unit 33 estimates the processing time using the past processing time data 42 and the performance-related data 43 will be described later with reference to FIGS. 3 and 4.

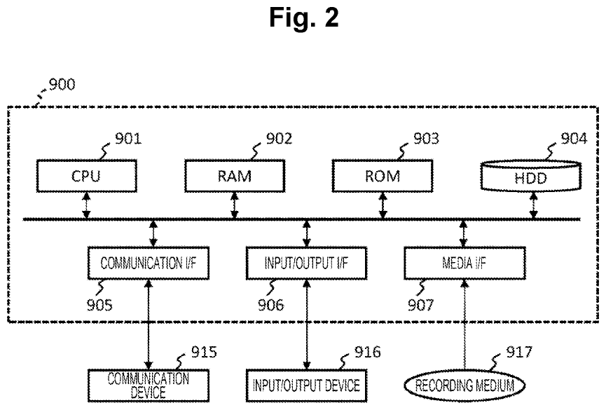

FIG. 2 is a hardware configuration diagram of the server 30.

The server 30 is configured as a computer 900 including a CPU 901, a RAM 902, a ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads and writes data from and to a recording medium 917. Furthermore, the CPU 901 controls each processing unit by executing a program (also referred to as an application or an app for abbreviation thereof) read into the RAM 902. In addition, the program can be distributed via a communication line or distributed by being recorded in the recording medium 917 such as a CD-ROM.

FIG. 3 is a detailed configuration diagram of the polling control system.

FIG. 4 is a sequence diagram illustrating an operation of the polling control system.

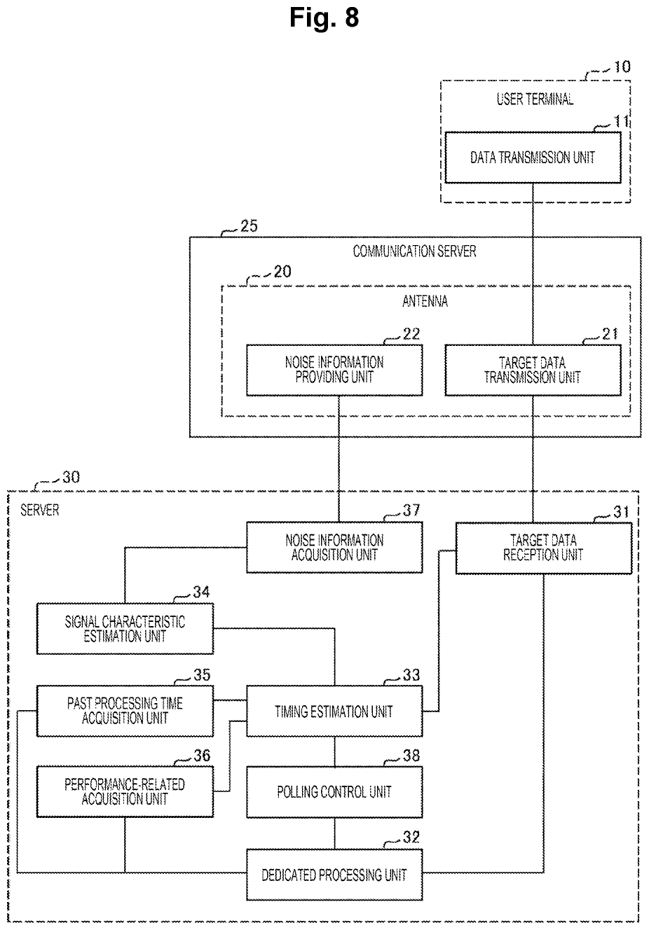

Hereinafter, each component in FIG. 3 and FIG. 8 to be described later will be described in detail with reference to FIG. 4 as appropriate.

The user terminal 10 includes a data transmission unit 11.

The data transmission unit 11 transmits target data generated in the user terminal 10 to a target data transmission unit 21 of an antenna 20 via a wireless communication means (S11: data transmission). A communication path between the data transmission unit 11 and the target data transmission unit 21 may use wired data transmission instead of wireless data transmission. Note that, in the transmission processing of S11, noise may be generated and the target data may be damaged.

The antenna 20 is a wireless communication module mounted on the server 30 side. The antenna 20 transmits and receives radio waves for data communication and can measure the amount of noise of the radio waves.

The target data transmission unit 21 processes a part of the target data received from the data transmission unit 11 via the communication path, and transmits the processed part to a target data reception unit 31 via a communication path (S12: target data transmission). The communication path between the target data transmission unit 21 and the target data reception unit 31 may use wired data transmission instead of wireless data transmission. Furthermore, the antenna 20 (target data transmission unit 21) may be provided outside the server 30 or may be incorporated.

Alternatively, as illustrated in FIG. 8, the antenna 20 may be mounted on a (independent) communication server 25, which is a device different from both the server 30 and the user terminal 10, and the communication server 25 and the server 30 may be connected by wire. This makes it possible to support the fifth generation (5G) mobile phone communication standard.

The server 30 includes the target data reception unit 31, the dedicated processing unit 32, the timing estimation unit 33, the signal characteristic estimation unit 34, a past processing time acquisition unit 35, a performance-related acquisition unit 36, a noise information acquisition unit 37, and the polling control unit 38.

Note that the dedicated information acquisition unit 39 in FIG. 1 is embodied as the past processing time acquisition unit 35 and the performance-related acquisition unit 36 in FIG. 3.

The target data reception unit 31 receives the target data from the target data transmission unit 21 (S13: target data reception). After the target data is converted into a format in which the dedicated processing unit 32 can perform signal processing, the dedicated processing unit 32 is requested to perform dedicated processing (dedicated processing is offloaded).

That is, the offload source application 71 in FIG. 1 corresponds to the target data reception unit 31 in FIG. 3. Meanwhile, the offload source application 71 may be configured to include the data transmission unit 11, the target data transmission unit 21, and the target data reception unit 31.

Note that data input/output between the target data reception unit 31 and the dedicated processing unit 32 may be via a network. That is, the dedicated processing unit 32 may be mounted in a housing different from the server 30. Furthermore, in an interface between the target data reception unit 31 and the dedicated processing unit 32, the forms of a function name and an argument may be the same as those of an existing API such that existing signal processing software can be used as it is.

The dedicated processing unit 32 performs dedicated processing on the basis of the target data input from the target data reception unit 31 (S14: dedicated processing). In a case where the processing has been completed, the dedicated processing unit 32 outputs a processing result in response to a result confirmation from the polling control unit 38.

The dedicated processing unit 32 may be implemented as the dedicated software 72 in FIG. 1 or may be implemented as the accelerator HW 91.

After inputting the target data to the dedicated processing unit 32, the target data reception unit 31 notifies the timing estimation unit 33 of the signal characteristic data 41 such as the size of the target data (S15: signal characteristic data notification).

The timing estimation unit 33 requests the signal characteristic estimation unit 34, the past processing time acquisition unit 35, or the performance-related acquisition unit 36 to acquire at least one of (information 1) to (information 3) provided from the estimation data storage unit 40 (S16: data acquisition request).

(Information 1) The signal characteristic data 41 provided via the signal characteristic estimation unit 34.

(Information 2) The past processing time data 42 provided via the past processing time acquisition unit 35. The past processing time data 42 is, for example, the latest processing time read from logs of the dedicated processing unit 32.

(Information 3) The performance-related data 43 provided via the performance-related acquisition unit 36. The performance-related data 43 is performance-related information of the dedicated processing unit 32, and is defined by the input status of other tasks other than the target data, accelerator performance, and the like.

These (information 1) to (information 3) are information that causes prolongation (delay) of a processing time, and are expressed as, for example, degrees of delay in 10 stages or the like, and the larger the numerical value of a degree of delay, the longer the processing time.

The timing estimation unit 33 estimates the processing time (for example, the time required for error correction of the target data) of the dedicated processing unit 32 to which the dedicated processing is offloaded, using (information 1) to (information 3) requested in S16 (S31: timing estimation). That is, the timing estimation unit 33 estimates the processing time during which the dedicated processing unit 32 executes the dedicated processing on the current target data offloaded to the dedicated processing unit 32.

In S31, the timing estimation unit 33 calculates the processing completion time as a result of elapse (addition) of the estimated processing time from the time at which the dedicated processing is offloaded to the dedicated processing unit 32 as a starting point.

For example, the timing estimation unit 33 converts a degree of delay into the processing time. Note that each piece of information does not have to be a degree of delay, and original data acquired by each functional unit may be received and converted into the processing time by the timing estimation unit 33. Furthermore, in the estimation of the processing time, weighting may be performed on each of (information 1) to (information 3), and the weighted information may be reflected in conversion into the processing time.

Furthermore, the timing estimation unit 33 outputs the processing completion time of S31 to the polling control unit 38 to cause the polling control unit 38 to poll the dedicated processing unit 32 at the processing completion time (S32: polling control).

Details (S21 to S25) of the processing of acquiring (information 1) to (information 3) will be described below.

(Information 1) The signal characteristic estimation unit 34 requests the noise information acquisition unit 37 to acquire noise information (S21: noise information acquisition request). The noise information is information indicating noise included in the input signal of the target data input to the offload source application 71.

On the basis of the noise information obtained from the noise information acquisition unit 37, the signal characteristic estimation unit 34 estimates (the degree of delay of) the signal characteristic data 41, for example, by calculating a function in which the processing time becomes longer as the amount of noise when the current target data is transmitted is larger (S25: signal characteristic estimation). The signal characteristic estimation unit 34 responds to the timing estimation unit 33 with (the degree of delay of) the estimated signal characteristic data 41.

The signal characteristic data 41 is, for example, the amount of errors of the target data calculated on the basis of the data such as the size of the target data obtained from the timing estimation unit 33 and the amount of noise obtained from the noise information acquisition unit 37.

Note that, instead of the signal characteristic estimation unit 34, the timing estimation unit 33 may be caused to calculate the amount of errors of the target data on the basis of the data such as the amount of noise. Furthermore, the signal characteristic estimation unit 34 may estimate the amount of errors of the target data from data acquired in decoding processing by the dedicated processing unit 32.

The noise information acquisition unit 37 acquires information regarding the amount of noise of the input signal from a noise information providing unit 22 with the notification from the signal characteristic estimation unit 34 as a trigger (S24b: noise information acquisition), and returns the information to the signal characteristic estimation unit 34. Alternatively, instead of using the notification from the signal characteristic estimation unit 34 as a trigger, the noise information may be transmitted simultaneously when the target data is transmitted from the target data transmission unit 21 to the target data reception unit 31.

The noise information providing unit 22 provides the noise information acquisition unit 37 with the amount of noise of the communication means used to transmit the target data as a number (S24a: noise information provision). The noise information providing unit 22 responds with an average of the amount of noise over the latest fixed period of time. Alternatively, the noise information providing unit 22 may receive a past time as an input and respond with the recorded amount of noise at the time. Furthermore, the noise information providing unit 22 may be used for maintenance work (optimum arrangement of communication facilities). For example, the noise information providing unit 22 may notify a maintenance person of an alert in a case where the amount of noise is large, thereby identifying a cause of radio wave interference.

(Information 2) The past processing time acquisition unit 35 estimates (the degree of delay of) the past processing time data 42 on the basis of input information such as a processing time (past processing time) required for the dedicated processing unit 32 to perform dedicated processing on past target data (S22: past processing time acquisition). In the estimation processing of S22, for example, the past processing time acquisition unit 35 calculates a function in which the processing time of the current target data becomes longer as the processing time required for the past dedicated processing is longer.

The past processing time may be acquired by use of statistical information of processing time from offloading (request) of processing to a response (response) in the dedicated processing unit 32.

The past processing time acquisition unit 35 responds to the timing estimation unit 33 with (the degree of delay of) the past processing time data 42. The input information may include, in addition to the past processing time from the dedicated processing unit 32, relationship information between the past processing time and the data size.

Alternatively, instead of the past processing time acquisition unit 35, the polling control unit 38 may respond to the timing estimation unit 33 with the past processing time recorded in the past. Furthermore, the past processing time acquisition unit 35 may not have the function of estimating the degree of delay, and a past processing time list according to the data size may be directly sent to the timing estimation unit 33.

(Information 3) The performance-related acquisition unit 36 calculates (the degree of delay of) the performance-related data 43 on the basis of the amount of current other tasks of the dedicated processing unit 32 (the input status of tasks other than the task of the target data predicted this time) (S23: performance-related data acquisition). In the calculation processing of S23, for example, the performance-related acquisition unit 36 calculates a function in which the processing time of the current target data becomes longer as the amount of current other tasks of the dedicated processing unit 32 other than the offloaded current dedicated processing is larger.

The performance-related acquisition unit 36 responds to the timing estimation unit 33 with (the degree of delay of) the performance-related data 43. Alternatively, the performance-related acquisition unit 36 may not have the function of estimating the degree of delay, and the amount of tasks of the dedicated processing unit 32 may be directly sent to the timing estimation unit 33.

The polling control unit 38 performs control to make an inquiry about a result of polling to the dedicated processing unit 32 on the basis of the processing completion time (timing) of the dedicated processing unit 32 received from the timing estimation unit 33.

That is, the polling control unit 38 waits for execution of the polling processing for requesting the dedicated processing unit 32 to transmit an execution result of the dedicated processing until the estimated processing time elapses. The polling control unit 38 executes the polling processing on the dedicated processing unit 32 when the estimated processing time has elapsed.

Here, the polling control unit 38 changes the CPU 70 of the server 30 to a mode (sleep mode, suspend mode, or the like) that saves more power than a normal power mode in the waiting time until the processing completion time. The polling control unit 38 then returns to the normal power mode when the waiting time elapses, and thus can achieve further power saving.

Alternatively, the polling control unit 38 may cause another task other than the polling of the target data to be executed during the waiting time.

### [Effects]

The server 30 of the present invention is characterized in including: the timing estimation unit 33 that estimates a processing time during which the dedicated processing unit 32 executes dedicated processing on current target data offloaded to the dedicated processing unit 32; and
the polling control unit 38 that waits for execution of polling processing for requesting the dedicated processing unit 32 to transmit an execution result of the dedicated processing until the estimated processing time elapses, and
executes the polling processing on the dedicated processing unit 32 when the estimated processing time has elapsed.

As a result, the polling processing is waited for until the dedicated processing unit 32 completes the dedicated processing, so that power saving can be achieved. In addition, the polling processing is executed at an appropriate timing when the dedicated processing unit 32 completes the dedicated processing, so that real-time property can be achieved.

The present invention is characterized in that the polling control unit 38 changes the server 30 to a mode that saves more power than a normal power mode during a period in which execution of the polling processing is waited for, and changes the server 30 to the normal power mode when the polling processing is executed.

As a result, not only waiting for the polling processing but also changing to the power saving mode makes it possible to achieve further power saving in the waiting period.

The present invention is characterized in that the timing estimation unit 33 estimates the processing time by calculating a function in which the processing time becomes longer as the amount of noise when the current target data is transmitted is larger.

As a result, the amount of noise included in the target data is reflected in the processing time to be estimated, so that the accuracy of the processing time to be estimated is improved, and the number of failures in data acquisition by polling is reduced.

The present invention is characterized in that the timing estimation unit 33 estimates the processing time by calculating a function in which the processing time of the current target data becomes longer as a processing time required for past dedicated processing is longer.

As a result, the processing time required for the past dedicated processing is reflected in the processing time to be estimated, so that the accuracy of the processing time to be estimated is improved, and the number of failures in data acquisition by polling is reduced.

The present invention is characterized in that the timing estimation unit 33 estimates the processing time by calculating a function in which the processing time of the current target data becomes longer as the amount of current other tasks of the dedicated processing unit 32 other than the offloaded current dedicated processing is larger.

As a result, the amount of current other tasks of the dedicated processing unit 32 is reflected in the processing time to be estimated, so that the accuracy of the processing time to be estimated is improved, and the number of failures in data acquisition by polling is reduced.

### REFERENCE SIGNS LIST

10 User terminal
11 Data transmission unit
20 Antenna
21 Target data transmission unit
22 Noise information providing unit
25 Communication server
30 Server (polling control device)
31 Target data reception unit
32 Dedicated processing unit (predetermined processing unit)
33 Timing estimation unit (processing time estimation unit)
34 Signal characteristic estimation unit
35 Past processing time acquisition unit
36 Performance-related acquisition unit
37 Noise information acquisition unit
38 Polling control unit
39 Dedicated information acquisition unit
40 Estimation data storage unit
41 Signal characteristic data
42 Past processing time data
43 Performance-related data
70 CPU
71 Offload source application
72 Dedicated software
80 OS
90 Server HW
91 Accelerator HW

1. A polling control device comprising:
a processing time estimation unit, including one or more processors, configured to estimate a processing time during which a predetermined processing unit executes predetermined processing on current target data offloaded to the predetermined processing unit; and
a polling control unit, including one or more processors, configured to wait for execution of polling processing for requesting the predetermined processing unit to transmit an execution result of the predetermined processing until the estimated processing time elapses, and
execute the polling processing on the predetermined processing unit when the estimated processing time has elapsed.

2. The polling control device according to claim 1, wherein the polling control unit is configured to change the polling control device to a mode that saves more power than a normal power mode during a period in which execution of the polling processing is waited for, and change the polling control device to the normal power mode when the polling processing is executed.

3. The polling control device according to claim 1, wherein the processing time estimation unit is configured to estimate the processing time by calculating a function in which the processing time becomes longer as an amount of noise when the current target data is transmitted is larger.

4. The polling control device according to claim 1, wherein the processing time estimation unit is configured to estimate the processing time by calculating a function in which the processing time of the current target data becomes longer as a processing time required for past predetermined processing is longer.

5. The polling control device according to claim 1, wherein the processing time estimation unit is configured to estimate the processing time by calculating a function in which the processing time of the current target data becomes longer as an amount of current other tasks of the predetermined processing unit other than the offloaded current predetermined processing is larger.

6. A polling control system comprising:
the polling control device according claim 1; and
a user terminal, wherein
the user terminal is configured to transmit the current target data to the polling control device.

7. A polling control method performed by a polling control device, the polling control method comprising:
estimating a processing time during which a predetermined processing unit executes predetermined processing on current target data offloaded to the predetermined processing unit;
waiting for execution of polling processing for requesting the predetermined processing unit to transmit an execution result of the predetermined processing until the estimated processing time elapses; and
executing the polling processing on the predetermined processing unit when the estimated processing time has elapsed.

8. A non-transitory computer-readable storage medium storing polling control program for causing a computer to function as the polling control device to perform operations comprising:
estimating a processing time during which a predetermined processing unit executes predetermined processing on current target data offloaded to the predetermined processing unit;
waiting for execution of polling processing for requesting the predetermined processing unit to transmit an execution result of the predetermined processing until the estimated processing time elapses; and
executing the polling processing on the predetermined processing unit when the estimated processing time has elapsed.

9. The polling control method according to claim 7, further comprising:
changing the polling control device to a mode that saves more power than a normal power mode during a period in which execution of the polling processing is waited for, and changing the polling control device to the normal power mode when the polling processing is executed.

10. The polling control method according to claim 7, further comprising:
estimating the processing time by calculating a function in which the processing time becomes longer as an amount of noise when the current target data is transmitted is larger.

11. The polling control method according to claim 7, further comprising:
estimating the processing time by calculating a function in which the processing time of the current target data becomes longer as a processing time required for past predetermined processing is longer.

12. The polling control method according to claim 7, further comprising:
estimating the processing time by calculating a function in which the processing time of the current target data becomes longer as an amount of current other tasks of the predetermined processing unit other than the offloaded current predetermined processing is larger.

13. The non-transitory computer-readable storage medium according to claim 8, wherein the operations further comprise:
changing the polling control device to a mode that saves more power than a normal power mode during a period in which execution of the polling processing is waited for, and changing the polling control device to the normal power mode when the polling processing is executed.

14. The non-transitory computer-readable storage medium according to claim 8, wherein the operations further comprise:
estimating the processing time by calculating a function in which the processing time becomes longer as an amount of noise when the current target data is transmitted is larger.

15. The non-transitory computer-readable storage medium according to claim 8, wherein the operations further comprise:
estimating the processing time by calculating a function in which the processing time of the current target data becomes longer as a processing time required for past predetermined processing is longer.

16. The polling control method according to claim 7, further comprising:
estimating the processing time by calculating a function in which the processing time of the current target data becomes longer as an amount of current other tasks of the predetermined processing unit other than the offloaded current predetermined processing is larger.
